(19) United States
(12) Patent Application Publication
(10) Pub. No.: US 2021/0252874 A1
(43) Pub. Date: Aug. 19, 2021

(54) CONTINUOUS FREQUENCY BASED PRINT PIPELINE GENERATION

(71) Applicant: Hewlett-Packard Development Company, L.P., Spring, TX (US)

(72) Inventors: Jay S. Gondek, Vancouver, WA (US); Jason M. Quintana, Vancouver, WA (US); Weiyun Sun, Vancouver, WA (US)

(73) Assignee: Hewlett-Packard Development Company, L.P., Spring, TX (US)

(21) Appl. No.: 17/056,100

(22) PCT Filed: Oct. 31, 2018
(86) PCT No.: PCT/US2018/058510

§ 371 Date: Nov. 17, 2020

(51) Int. Cl. B41J 2/36; B41J 2/355; B41J 2/05; B41J 2/045; G06K 15/02

(52) U.S. Cl. CPC B41J 2/36; B41J 2/3556; G06K 15/028; B41J 2/04541; B41J 2/05

(57) ABSTRACT

In some examples, continuous frequency based print pipeline generation may include ascertaining an input image that is to be printed. For a specified pixel of the input image, a first frequency and a second frequency that respectively correspond to first and second colors may be determined. Based on the first frequency and the second frequency, an intermediate frequency that is to be generated to produce an intermediate color relative to the first and second colors may be determined. The intermediate frequency may be converted to discrete pulses. Operation of a printhead that is to print the specified pixel may be controlled based on the discrete pulses.

### BACKGROUND

A variety of techniques may be used for printing on media. One such technique includes the use of thermal printheads. Thermal printheads may utilize a set of resistor elements that are heated to apply heat directly to the media, or to a thermal transfer ribbon. The applied heat may produce a specified print pattern on the media. The specified print pattern may include, for example, text, images, and other such patterns.

### BRIEF DESCRIPTION OF DRAWINGS

Features of the present disclosure are illustrated by way of example and not limited in the following figure(s), in which like numerals indicate like elements, in which:

FIG. 1 illustrates an example layout of a continuous frequency based print pipeline generation apparatus;

FIG. 2 illustrates an example of machine readable instructions to generate discrete pulses to illustrate operation of the continuous frequency based print pipeline generation apparatus of FIG. 1;

FIG. 3 illustrates an example of discrete pulses generated by the machine readable instructions of FIG. 2 to illustrate operation of the continuous frequency based print pipeline generation apparatus of FIG. 1;

FIG. 4 illustrates an example of variable frequency pulses to illustrate operation of the continuous frequency based print pipeline generation apparatus of FIG. 1;

FIG. 5 illustrates an example of machine readable instructions that include a decay to generate discrete pulses to illustrate operation of the continuous frequency based print pipeline generation apparatus of FIG. 1;

FIG. 6 illustrates an example block diagram for performing continuous frequency based print pipeline generation;

FIG. 7 illustrates an example flowchart of a method for performing continuous frequency based print pipeline generation; and

FIG. 8 illustrates a further example block diagram for performing continuous frequency based print pipeline generation.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Apparatuses for continuous frequency based print pipeline generation, methods for continuous frequency based print pipeline generation, and non-transitory computer readable media having stored thereon machine readable instructions to provide continuous frequency based print pipeline generation are disclosed herein. The apparatuses, methods, and non-transitory computer readable media disclosed herein provide for determination of a continuous frequency representation (e.g., a plurality of intermediate frequencies between two frequencies as disclosed herein) for each pixel of an input image. Further, for each pixel of the input image, the apparatuses, methods, and non-transitory computer readable media disclosed herein provide for conversion of the continuous frequency representation to discrete pulses that are sent to a printhead, such as a thermal printhead, to print the input image.

With respect to thermal printheads, thermal printers may generally activate the elements of a thermal printhead with a discrete set of pulses. For example, a single pulse frequency may be assigned to each color. This frequency may be generally described as a “duty cycle”. For example, thermal printers may use a duty cycle of 1 to activate yellow, a duty cycle of 7 to activate magenta, and a duty cycle of 15 to activate cyan. A duty cycle of 1 may mean that every bit is set, a duty cycle of 2 may mean that every other bit is set (e.g., frequency of ½), a duty cycle of 3 may mean that every 3^{rd} bit is set (e.g., frequency of ⅓), etc. Based on this printing technique of utilizing discrete duty cycles, it is technically challenging to expand color gamut and image sharpness.

In order to address the aforementioned technical challenges with respect to expansion of color gamut and image sharpness, for different uniform duty cycles that may correspond to different printhead heat amounts, the different heat amounts may be utilized to develop many combinations and intensities of layer and cross-layer colorants. In this regard, the apparatuses, methods, and non-transitory computer readable media disclosed herein may provide for a smooth transition between duty cycles.

With respect to other technical challenges addressed by the apparatuses, methods, and non-transitory computer readable media disclosed herein, adjustment of the intensity of a thermal signal may be accomplished by changing the length of the signal, which may result in unintended quality artifacts. For example, as the overall printhead heats up, the print media may need less heat energy from the printhead. In this regard, signal lengths within a pixel may be shortened to reduce the added heat, but this may change the distance over the pixel that activation occurs, and may present technical challenges with respect to balancing between cyan (C), magenta (M), and yellow (Y) components.

Yet further, a pixel may need to be pulsed thousands of times to achieve even a coarse set of useful duty-cycles. For example, with approximately 4000 pulses per pixel, the first 15 (or approximately 15) duty cycles may be used to print, giving few discrete choices. If the number of pulses to the pixel are reduced by 4×, with longer pulse widths, the number of discrete duty cycle choices may be reduced to about four, which may present technical challenges with respect to maintenance of print quality.

In order to address the aforementioned further technical challenges with respect to maintenance of print quality, with continuously variable frequency (or duty cycle) as disclosed herein, the apparatuses, methods, and non-transitory computer readable media disclosed herein may provide for the utilization of fewer pulses per pixel. Thus, the apparatuses, methods, and non-transitory computer readable media disclosed herein may provide for the frequency to change continuously (based on the utilization of intermediate frequencies), and translation of a continuous frequency definition of a printed pixel through a pipeline.

In examples described herein, module(s), as described herein, may be any combination of hardware and programming to implement the functionalities of the respective module(s). In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

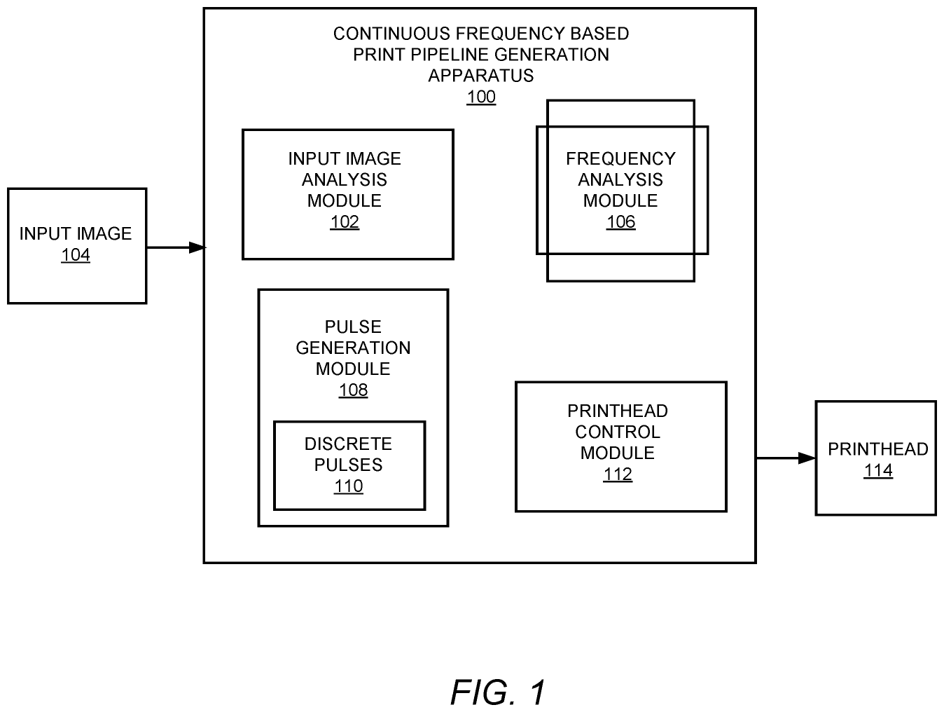

FIG. 1 illustrates an example layout of a continuous frequency based print pipeline generation apparatus (hereinafter also referred to as “apparatus 100”).

Referring to FIG. 1, the apparatus 100 may include input image analysis module 102 to ascertain an input image 104 that is to be printed.

A frequency analysis module 106 may determine, for a specified pixel of the input image 104, a first frequency and a second frequency that respectively correspond to first and second colors (e.g., yellow and red colors that may correspond, in an example, to a frequency of 0.5 and 0.2, but may otherwise be produced by different frequencies).

The frequency analysis module 106 may determine, based on the first frequency and the second frequency, an intermediate frequency (e.g., orange that may correspond to a frequency of 0.35) that is to be generated to produce an intermediate color relative to the first and second colors.

According to examples disclosed herein, the frequency analysis module 106 may determine, based on the first frequency and the second frequency, the intermediate frequency that is between (e.g., where 0.35 is between 0.5 and 0.2) the first frequency and the second frequency.

A pulse generation module 108 may convert the intermediate frequency to discrete pulses 110.

A printhead control module 112 may control, based on the discrete pulses 110, operation of a printhead 114 that is to print the specified pixel.

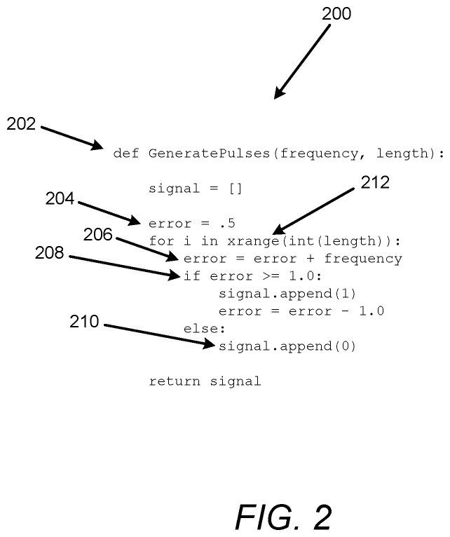

FIG. 2 illustrates an example of machine readable instructions to generate discrete pulses 110 to illustrate operation of the apparatus 100.

Referring to FIG. 2, the pulse generation module 108 may convert a continuous frequency representation to discrete pulses to be sent to the printhead 114 by utilizing, for example, the machine readable instructions 200. For example, at 202, the pulse generation module 108 may convert the intermediate frequency (e.g., frequency as shown in FIG. 2) to discrete pulses 110 by ascertaining a length of the intermediate frequency that is to be converted to discrete pulses 110. At 204, the pulse generation module 108 may ascertain an initial error value (e.g., 0.5 as shown in FIG. 2). At 206, the pulse generation module 108 may specify a modified error as a sum of the initial error value and the intermediate frequency. At 208, based on a determination that the modified error is greater than or equal to one, the pulse generation module 108 may specify a pulse value of one, and an error as the modified error minus one. At 210, based on a determination that the modified error is less than one, the pulse generation module 108 may specify the pulse value of zero. Further, at 212, the pulse generation module 108 may continue specification of pulse values for a range corresponding to the length.

The error may be initialized at 0.5 as shown in FIG. 2, but may otherwise be 0 or another value. A “1” with respect to the pulse values may represent a pulse firing event, and a “0” may represent a non-firing event. These values may provide for dithering of a floating point frequency into a discrete one-dimensional tone space.

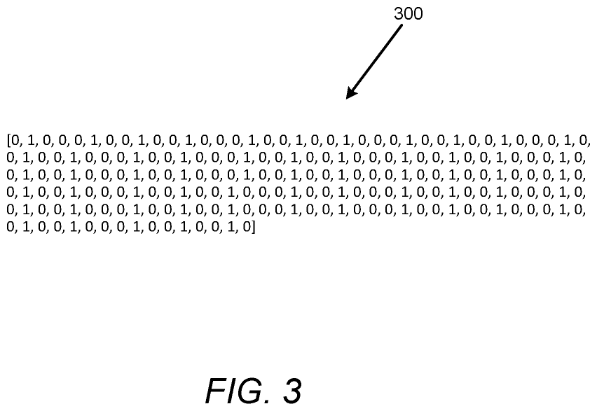

FIG. 3 illustrates an example of discrete pulses 110 generated by the machine readable instructions of FIG. 2 to illustrate operation of the apparatus 100.

Referring to FIG. 3, a frequency of 3.36 with a length of 60 may generate the discrete pulse values 300.

With respect to frequency and length as shown at 202 in FIG. 2, the frequency may represent a particular frequency that produces a specified color.

With respect to a printer control system that is based on duty cycle (e.g., an integer descriptor of frequencies, where a duty cycle of 1, every pulse is fired, a duty cycle of 2, every other pulse is fired, etc.), a difference between a duty cycle of 1 and 2 is ½ of the energy (e.g., no energy is expended between these duty cycles). For the apparatus 100, instead of implementing a duty cycle of 1, 2, etc., the spaces between these duty cycles may be utilized with respect utilization of the intermediate frequencies. Thus, small changes may be made to a frequency to print colors with respect to the spaces between these duty cycles.

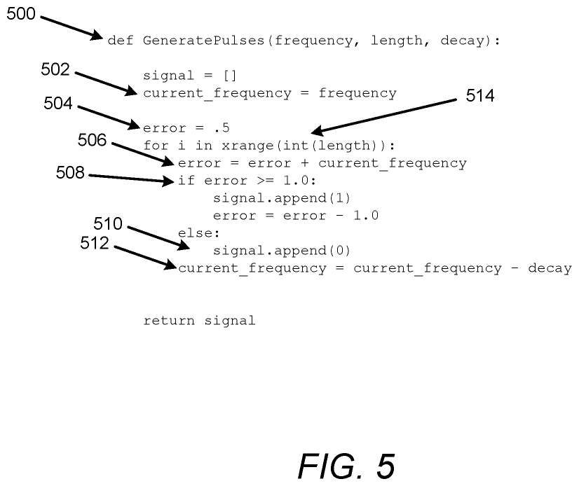

For efficiency, discrete pulses generated with respect to FIGS. 2 and 3 may also be implemented in terms of duty cycle, where fractional zero-spans may be tracked between pulses, including loop on pulses. In this regard, for a duty cycle of 7.4, with 100 pulses, the machine readable instructions 200 may loop 100 times, one loop for each pulse. The machine readable instructions of FIG. 5 may loop over the length of the signal, which may be computationally slower. With respect to zero-span, continuing the above example, for 100 pulses, a signal generator may send a pulse, and then send either 6 or 7 zeros (because 6.4 zeros may be needed). Keeping track of the fractional error may allow the dithering to occur. For 6.4 zeros, when rounding to 6, the error may be 0.4. The error may be further added to the next run of zeros (e.g., 6.4+0.4=6.8), where 6.8 zeros may be needed. This result may be rounded up, and on the next run, 7 zeros may be printed, and thus since 6.8 zeros are needed, the error is −0.2. Runs of zeros may be replicated between pulses. In this regard, when toggling between discrete runs of zeros between pulses (e.g., in the above example, 6 or 7 zeros), it may be computationally efficient to write a larger set of memory at once compared to one bit at a time. The pulse generation module 108 may perform dithering between n−1 and n zeros, for fractional duty cycles between n and n+1. In this regard, for a duty cycle of n, the zero patterns that are used may include either n−1 or n zeros. For example, as discussed above, for a duty cycle of 7.4, n is 7, and dithering may be performed between 6 and 7 zeros. For example, for a duty cycle of 7.5, for each 1 generated, 6 or 7 zeros may be generated based on accumulated error.

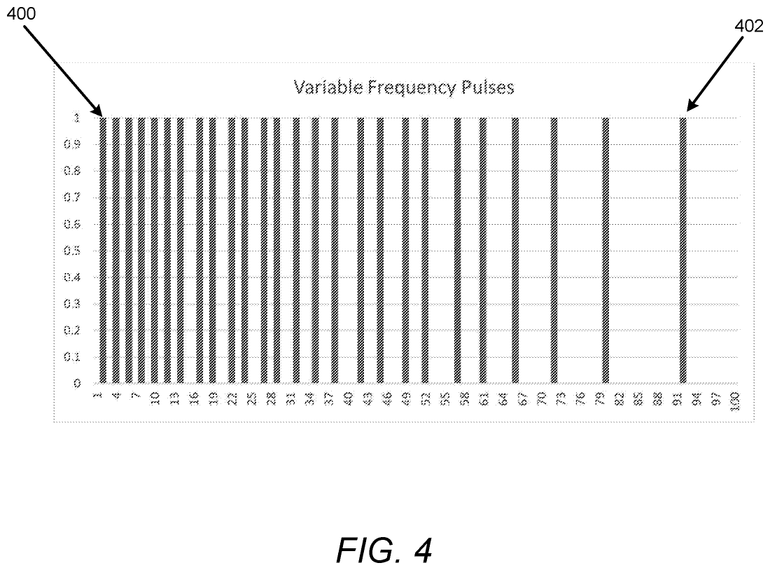

The pulse generation module 108 may provide for the use of a continuously variable frequency (e.g., the intermediate frequencies), or “duty cycle” signal to be sent to the printhead 114. For example, as disclosed herein, a frequency of 0.5 may produce a yellow color, and a frequency of 0.2 may produce a red color. With a continuously variable frequency, the pulse generation module 108 may provide for a relatively smooth transition between the yellow and red colors. Thus, frequencies such as 0.45, 0.40, 0.35, 0.30, 0.25, etc., may be used to create colors that are intermediate to the example yellow and red colors (thus providing a full range of colors), similar to the signal shown in the FIG. 4.

For example, FIG. 4 illustrates an example of variable frequency pulses (e.g., pulses corresponding to the intermediate frequencies as disclosed herein) to illustrate operation of the apparatus 100.

Referring to FIG. 4, the high frequency pulse at 400 may generate yellow, and the low frequency pulse at 402 may generate red. By dithering, any frequency in between may be generated to create multiple additional colors (e.g., orange colors) between yellow and red.

For the example of FIG. 4, the discrete pulses may be utilized for one or multiple pixels. For example, the frequencies at 1-7 may represent one pixel, 10-19 may represent another pixel, 22-31 may represent a further pixel, etc., to thus provide continuous transitions between adjacent pixels. Alternatively or additionally, all of the frequency shown in FIG. 4 may represent frequencies that are used for a single pixel.

The implementation of discrete pulses may also provide for uniform and continuous adjustment of the energy input to print media, based on the temperature of the print media which may vary due to the environment, or the temperature of various printer and printhead components which affect media pre-heat. For example, by consistently lowering the frequency of any given signal, input energy needed by the printhead 114 as well as energy transferred to print media may be reduced.

According to examples disclosed herein, the frequency analysis module 106 may determine, for first and second specified pixels (e.g., instead of a single pixel as disclosed herein) of the input image 104, a first frequency and a second frequency that respectively correspond to first and second colors (e.g., yellow and red colors as disclosed herein). In this regard, the printhead control module 112 may control, based on the discrete pulses, operation of a printhead that is to print the first and second specified pixels.

According to examples disclosed herein, the frequency analysis module 106 may determine, for a specified pixel or for first and second specified pixels of the input image 104, a first frequency and a second frequency that respectively correspond to first and second colors (e.g., yellow and red colors as disclosed herein). Further, the frequency analysis module 106 may determine, based on the first frequency and the second frequency, a plurality of intermediate frequencies that are to be generated to produce intermediate colors (e.g., orange as disclosed herein with respect to FIG. 4) relative to the first and second colors. In this regard, the frequency analysis module 106 may determine, based on the first frequency and the second frequency, the plurality of intermediate frequencies that are between the first frequency and the second frequency. The pulse generation module 108 may convert each of the intermediate frequencies to discrete pulses. The printhead control module 112 may control, based on the discrete pulses for each of the intermediate frequencies, operation of the printhead 114 that is to print the specified pixel, or the first and second specified pixels.

According to examples disclosed herein, as disclosed herein with respect to FIGS. 2-4, the pulse generation module 108 may ascertain, for each of the intermediate frequencies, a length and a corresponding frequency that is to be converted to discrete pulses. Further, for the frequency that is to be converted to discrete pulses 110, the pulse generation module 108 may ascertain an initial error value, and specify a modified error as a sum of the initial error value and the frequency. Based on a determination that the modified error is greater than or equal to one, the pulse generation module 108 may specify a pulse value of one, and an error as the modified error minus one. Based on a determination that the modified error is less than one, the pulse generation module 108 may specify the pulse value of zero. The pulse generation module 108 may continue specification of pulse values for a range corresponding to the length.

The implementation of discrete pulses may also provide for discrete portions of the printhead signal to continuously vary the energy input. That is, instead of printing a contiguous constant-duty cycle region within a pixel, a “decay” factor may be introduced to allow the signal to taper, to prevent the local build-up of excess heat. The decay factor may be used to sustain pixel activation over a longer duration (or distance). For example, magenta may activate with a frequency of 0.145, but to create an improved more-sustained magenta activation over the length of a pixel, the frequency sent to the printhead 114 may be reduced so that excess heat does not activate unwanted colors.

FIG. 5 illustrates an example of machine readable instructions that include a decay to generate discrete pulses to illustrate operation of the apparatus 100.

Referring to FIG. 5, the pulse generation module 108 may convert the intermediate frequency (e.g., frequency as shown in FIG. 5) to discrete pulses by ascertaining, as shown at 500, a length and a decay of the intermediate frequency that is to be converted to discrete pulses 110. At 502, the pulse generation module 108 may specify a current frequency as the intermediate frequency. At 504, the pulse generation module 108 may ascertain an initial error value. At 506, the pulse generation module 108 may specify a modified error as a sum of the initial error value and the current frequency. Based on a determination that the modified error is greater than or equal to one, at 508, the pulse generation module 108 may specify a pulse value of one, and an error as the modified error minus one. Based on a determination that the modified error is less than one, at 510, the pulse generation module 108 may specify the pulse value of zero. At 512, the pulse generation module 108 may specify the current frequency as a previously specified current frequency minus the decay. Further, at 514, the pulse generation module 108 may continue specification of pulse values for a range corresponding to the length.

The decay may provide for a smooth transition from a first duty cycle to a second duty cycle over the course of a pixel (or between multiple pixels). Thus, instead of a pixel first being at a duty cycle of 7 and then 5, the pixel may instead have a smooth transition between the duty cycle of 7 to the duty cycle of 5. With this decay factor, the frequency may be continuously reduced over the duration of the pulse stream segment. The decay function may be non-linear, and for some regions, the function may add to frequency rather than subtract. Other pixel regions may have a more complex function used to adjust frequency over the duration of the signal segment.

According to examples disclosed herein, the pulse generation module 108 may ascertain, for each of the intermediate frequencies (e.g., the plurality of intermediate frequencies as shown in FIG. 4), a length, a decay, and a corresponding frequency (e.g., one of the intermediate frequencies) that is to be converted to discrete pulses. For the frequency that is to be converted to discrete pulses, the pulse generation module 108 may specify a current frequency as the frequency, ascertain an initial error value, and specify a modified error as a sum of the initial error value and the current frequency. Based on a determination that the modified error is greater than or equal to one, the pulse generation module 108 may specify a pulse value of one, and an error as the modified error minus one. Based on a determination that the modified error is less than one, the pulse generation module 108 may specify the pulse value of zero. The pulse generation module 108 may specify the current frequency as a previously specified current frequency minus the decay. Further, the pulse generation module 108 may continue specification of pulse values for a range corresponding to the length.

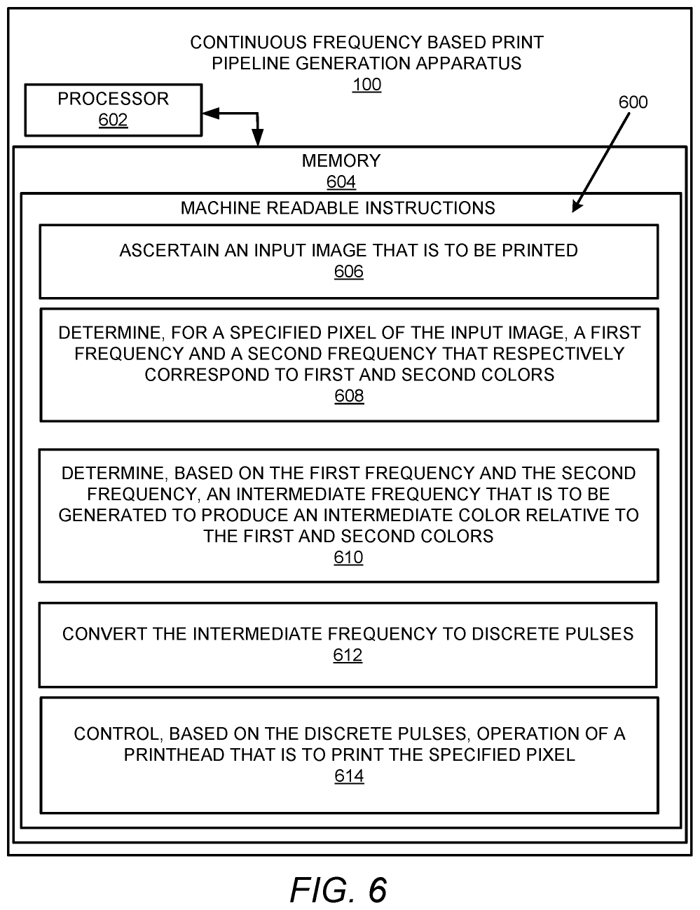

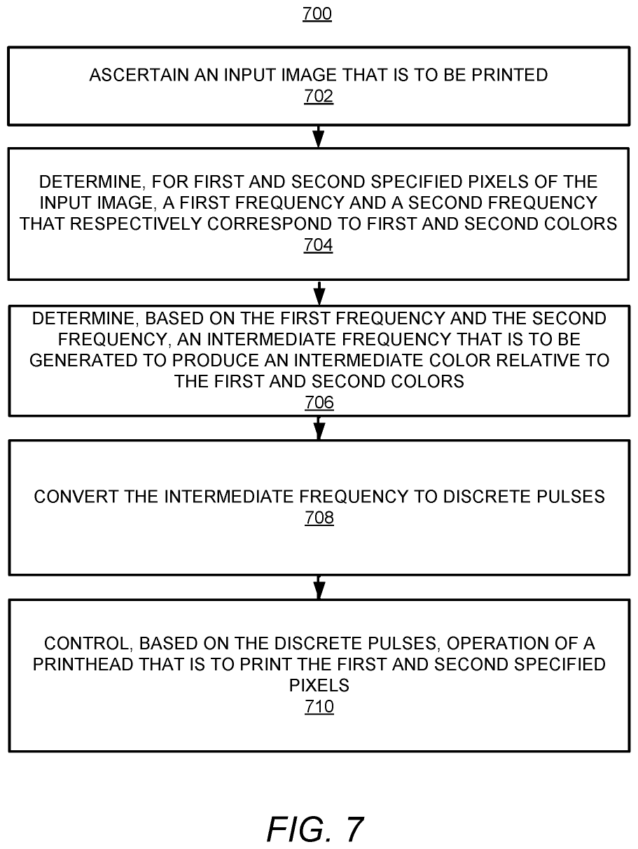

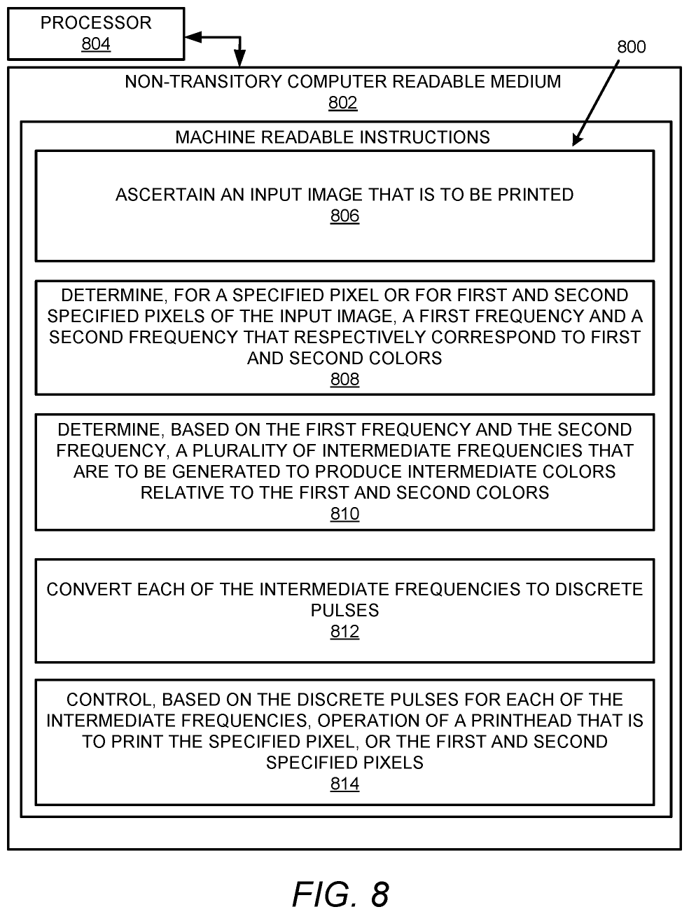

FIGS. 6-8 respectively illustrate an example block diagram 600, an example flowchart of a method 700, and a further example block diagram 800 for continuous frequency based print pipeline generation. The block diagram 600, the method 700, and the block diagram 800 may be implemented on the apparatus 100 described above with reference to FIG. 1 by way of example and not limitation. The block diagram 600, the method 700, and the block diagram 800 may be practiced in other apparatus. In addition to showing the block diagram 600, FIG. 6 shows hardware of the apparatus 100 that may execute the instructions of the block diagram 600. The hardware may include a processor 602, and a memory 604 (i.e., a non-transitory computer readable medium) storing machine readable instructions that when executed by the processor 602 cause the processor to perform the instructions of the block diagram 600. The memory 604 may represent a non-transitory computer readable medium. FIG. 7 may represent a method for performing continuous frequency based print pipeline generation. FIG. 8 may represent a non-transitory computer readable medium 802 having stored thereon machine readable instructions to perform continuous frequency based print pipeline generation. The machine readable instructions, when executed, cause a processor 804 to perform the instructions of the block diagram 800 also shown in FIG. 8.

The processor 602 of FIG. 6 and/or the processor 804 of FIG. 8 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 802 of FIG. 8), such as hardware storage devices (e.g., RAM (random access memory), ROM (read only memory), EPROM (erasable, programmable ROM), EEPROM (electrically erasable, programmable ROM), hard drives, and flash memory). The memory 604 may include a RAM, where the machine readable instructions and data for a processor may reside during runtime.

Referring to FIGS. 1-6, and particularly to the block diagram 600 shown in FIG. 6, the memory 604 may include instructions 606 to ascertain an input image 104 that is to be printed.

The processor 602 may fetch, decode, and execute the instructions 608 to determine, for a specified pixel of the input image 104, a first frequency and a second frequency that respectively correspond to first and second colors.

The processor 602 may fetch, decode, and execute the instructions 610 to determine, based on the first frequency and the second frequency, an intermediate frequency that is to be generated to produce an intermediate color relative to the first and second colors.

The processor 602 may fetch, decode, and execute the instructions 612 to convert the intermediate frequency to discrete pulses 110.

The processor 602 may fetch, decode, and execute the instructions 614 to control, based on the discrete pulses 110, operation of a printhead 114 that is to print the specified pixel.

Referring to FIGS. 1-5 and 7, and particularly FIG. 7, for the method 700, at block 702, the method may include ascertaining an input image 104 that is to be printed.

At block 704, the method may include determining, for first and second specified pixels of the input image 104, a first frequency and a second frequency that respectively correspond to first and second colors.

At block 706, the method may include determining, based on the first frequency and the second frequency, an intermediate frequency that is to be generated to produce an intermediate color relative to the first and second colors.

At block 708, the method may include converting the intermediate frequency to discrete pulses 110.

At block 710, the method may include controlling, based on the discrete pulses, operation of a printhead 114 that is to print the first and second specified pixels.

Referring to FIGS. 1-5 and 8, and particularly FIG. 8, for the block diagram 800, the non-transitory computer readable medium 802 may include instructions 806 to ascertain an input image 104 that is to be printed.

The processor 804 may fetch, decode, and execute the instructions 808 to determine, for a specified pixel or for first and second specified pixels of the input image, a first frequency and a second frequency that respectively correspond to first and second colors.

The processor 804 may fetch, decode, and execute the instructions 810 to determine, based on the first frequency and the second frequency, a plurality of intermediate frequencies that are to be generated to produce intermediate colors relative to the first and second colors.

The processor 804 may fetch, decode, and execute the instructions 812 to convert each of the intermediate frequencies to discrete pulses 110.

The processor 804 may fetch, decode, and execute the instructions 814 to control, based on the discrete pulses 110 for each of the intermediate frequencies, operation of a printhead 114 that is to print the specified pixel, or the first and second specified pixels.

What has been described and illustrated herein is an example along with some of its variations. The terms, descriptions and figures used herein are set forth by way of illustration and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium storing machine readable instructions that when executed by the processor cause the processor to:
ascertain an input image that is to be printed;
determine, for a specified pixel of the input image, a first frequency and a second frequency that respectively correspond to first and second colors;
determine, based on the first frequency and the second frequency, an intermediate frequency that is to be generated to produce an intermediate color relative to the first and second colors;
convert the intermediate frequency to discrete pulses; and
control, based on the discrete pulses, operation of a printhead that is to print the specified pixel.

2. The apparatus according to claim 1, wherein the instructions to determine, based on the first frequency and the second frequency, the intermediate frequency that is to be generated to produce the intermediate color relative to the first and second colors, are further to cause the processor to:
determine, based on the first frequency and the second frequency, the intermediate frequency that is between the first frequency and the second frequency.

3. The apparatus according to claim 1, wherein the instructions to convert the intermediate frequency to discrete pulses, are further to cause the processor to:
ascertain a length of the intermediate frequency that is to be converted to discrete pulses;
ascertain an initial error value;
specify a modified error as a sum of the initial error value and the intermediate frequency;
based on a determination that the modified error is greater than or equal to one, specify a pulse value of one, and an error as the modified error minus one;
based on a determination that the modified error is less than one, specify the pulse value of zero; and
continue specification of pulse values for a range corresponding to the length.

4. The apparatus according to claim 1, wherein the instructions to convert the intermediate frequency to discrete pulses, are further to cause the processor to:
ascertain a length and a decay of the intermediate frequency that is to be converted to discrete pulses;
specify a current frequency as the intermediate frequency;
ascertain an initial error value;
specify a modified error as a sum of the initial error value and the current frequency;
based on a determination that the modified error is greater than or equal to one, specify a pulse value of one, and an error as the modified error minus one;
based on a determination that the modified error is less than one, specify the pulse value of zero;
specify the current frequency as a previously specified current frequency minus the decay; and
continue specification of pulse values for a range corresponding to the length.

5. The apparatus according to claim 1, wherein the instructions to control, based on the discrete pulses, operation of the printhead that is to print the specified pixel, are further to cause the processor to:
control, based on the discrete pulses, operation of the printhead that includes a thermal printhead.

6. A computer implemented method comprising:
ascertaining an input image that is to be printed;
determining, for first and second specified pixels of the input image, a first frequency and a second frequency that respectively correspond to first and second colors;
determining, based on the first frequency and the second frequency, an intermediate frequency that is to be generated to produce an intermediate color relative to the first and second colors;
converting the intermediate frequency to discrete pulses; and
controlling, based on the discrete pulses, operation of a printhead that is to print the first and second specified pixels.

7. The computer implemented method according to claim 6, wherein determining, based on the first frequency and the second frequency, the intermediate frequency that is to be generated to produce the intermediate color relative to the first and second colors, further comprises:
determining, based on the first frequency and the second frequency, the intermediate frequency that is between the first frequency and the second frequency.

8. The computer implemented method according to claim 6, wherein converting the intermediate frequency to discrete pulses, further comprises:
ascertaining a length of the intermediate frequency that is to be converted to discrete pulses;
ascertaining an initial error value;
specifying a modified error as a sum of the initial error value and the intermediate frequency;
based on a determination that the modified error is greater than or equal to one, specifying a pulse value of one, and an error as the modified error minus one;
based on a determination that the modified error is less than one, specifying the pulse value of zero; and
continuing specification of pulse values for a range corresponding to the length.

9. The computer implemented method according to claim 6, wherein converting the intermediate frequency to discrete pulses, further comprises:
ascertaining a length and a decay of the intermediate frequency that is to be converted to discrete pulses;
specifying a current frequency as the intermediate frequency;
ascertaining an initial error value;
specifying a modified error as a sum of the initial error value and the current frequency;
based on a determination that the modified error is greater than or equal to one, specifying a pulse value of one, and an error as the modified error minus one;
based on a determination that the modified error is less than one, specifying the pulse value of zero;
specifying the current frequency as a previously specified current frequency minus the decay; and
continuing specification of pulse values for a range corresponding to the length.

10. The computer implemented method according to claim 6, wherein controlling, based on the discrete pulses, operation of the printhead that is to print the first and second specified pixels, further comprises:
controlling, based on the discrete pulses, operation of the printhead that includes a thermal printhead.

11. A non-transitory computer readable medium having stored thereon machine readable instructions, the machine readable instructions, when executed, cause a processor to:
ascertain an input image that is to be printed;
determine, for a specified pixel or for first and second specified pixels of the input image, a first frequency and a second frequency that respectively correspond to first and second colors;
determine, based on the first frequency and the second frequency, a plurality of intermediate frequencies that are to be generated to produce intermediate colors relative to the first and second colors;
convert each of the intermediate frequencies to discrete pulses; and
control, based on the discrete pulses for each of the intermediate frequencies, operation of a printhead that is to print the specified pixel, or the first and second specified pixels.

12. The non-transitory computer readable medium according to claim 11, wherein the machine readable instructions to determine, based on the first frequency and the second frequency, the plurality of intermediate frequencies that are to be generated to produce intermediate colors relative to the first and second colors, when executed, further cause the processor to:
determine, based on the first frequency and the second frequency, the plurality of intermediate frequencies that are between the first frequency and the second frequency.

13. The non-transitory computer readable medium according to claim 11, wherein the machine readable instructions to convert each of the intermediate frequencies to discrete pulses, when executed, further cause the processor to:
ascertain, for each of the intermediate frequencies, a length and a corresponding frequency that is to be converted to discrete pulses;
for the frequency that is to be converted to discrete pulses,
ascertain an initial error value,
specify a modified error as a sum of the initial error value and the frequency,
based on a determination that the modified error is greater than or equal to one, specify a pulse value of one, and an error as the modified error minus one, and
based on a determination that the modified error is less than one, specify the pulse value of zero; and
continue specification of pulse values for a range corresponding to the length.

14. The non-transitory computer readable medium according to claim 11, wherein the machine readable instructions to convert each of the intermediate frequencies to discrete pulses, when executed, further cause the processor to:
ascertain, for each of the intermediate frequencies, a length, a decay, and a corresponding frequency that is to be converted to discrete pulses;
for the frequency that is to be converted to discrete pulses,
specify a current frequency as the frequency,
ascertain an initial error value,
specify a modified error as a sum of the initial error value and the current frequency,
based on a determination that the modified error is greater than or equal to one, specify a pulse value of one, and an error as the modified error minus one,
based on a determination that the modified error is less than one, specify the pulse value of zero, and
specify the current frequency as a previously specified current frequency minus the decay; and
continue specification of pulse values for a range corresponding to the length.

15. The non-transitory computer readable medium according to claim 11, wherein the machine readable instructions to control, based on the discrete pulses for each of the intermediate frequencies, operation of the printhead that is to print the specified pixel, or the first and second specified pixels, when executed, further cause the processor to:
control, based on the discrete pulses for each of the intermediate frequencies, operation of the printhead that includes a thermal printhead.
